(19) United States
(12) Patent Application Publication
(10) Pub. No.: US 2025/0240844 A1
(43) Pub. Date: Jul. 24, 2025

(54) METHOD AND APPARATUS OF RECONNECTING A RADIO LINK FOR A MULTI-CONNECTIVITY SCENARIO

(71) Applicant: Lenovo (Beijing) Limited, Beijing (CN)

(72) Inventors: Min Xu, Beijing (CN); Congchi Zhang, Shanghai (CN); Lianhai Wu, Beijing (CN); Ran Yue, Beijing (CN); Jing Han, Beijing (CN)

(73) Assignee: Lenovo (Beijing) Limited, Beijing (CN)

(21) Appl. No.: 18/700,966

(22) PCT Filed: Oct. 15, 2021
(86) PCT No.: PCT/CN2021/124081

§ 371 Date: Apr. 12, 2024

(51) Int. Cl. H04W 76/19; H04L 43/0864; H04W 36/30

(52) U.S. Cl. CPC H04W 76/19; H04L 43/0864; H04W 36/305

(57) ABSTRACT

Embodiments of the present disclosure relate to methods and apparatuses for reconnecting a radio link for a multi-connectivity scenario. According to an embodiment of the present application, a user equipment (UE) includes a processor and a wireless transceiver coupled to the processor; and the processor is configured: to determine, based on a time related condition, whether to perform a recovery operation to reconnect the UE to a master node (MN) or at least one secondary node (SN), wherein the time related condition is associated with “the MN” or “the at least one SN” or “the MN and the at least one SN”; and to perform the recovery operation, in response to determining that the recovery operation is to be performed.

### TECHNICAL FIELD

Embodiments of the present disclosure generally relate to wireless communication technology, especially to a method and apparatus of reconnecting a radio link for a multi-connectivity scenario.

### BACKGROUND

In general, a next generation-radio access network (NG-RAN) supports a multi-radio dual connectivity (MR-DC) mechanism whereby a user equipment (UE) in a connected mode is configured to utilize radio resources provided by two distinct schedulers, located in two different NG-RAN nodes connected via a non-ideal backhaul, one providing NR access and the other one providing either evolved universal terrestrial radio access (E-UTRA) or new radio (NR) access.

In a MR-DC mechanism, one of the NG-RAN nodes acts as a master node (MN) and the other acts as a secondary node (SN). The MN and SN are connected via a network interface and at least the MN is connected to the core network. The Master Cell Group (MCG) is a group of serving cells associated with the MN comprising of the Primary Cell (PCell) and optionally one or more Secondary Cells (SCells). The Secondary Cell Group (SCG) is a group of serving cells associated with the SN comprising of the Primary Secondary Cell (PSCell) and optionally one or more SCells. The PCell and PSCell can also be collectively called the Special Cell (SpCell).

A non-terrestrial network (NTN) environment refers to a network, or segment of networks using radio frequency resources on board a satellite. The satellite in NTN can be a Geostationary Earth Orbiting (GEO) satellite with fixed location to the Earth, or a Low Earth Orbiting (LEO) satellite orbiting around the Earth. Support of DC or multi-connectivity in NTN is deprioritized in 3rd Generation Partnership Project (3GPP) Rel-17 due to limited time budget and is one of the most expected features to be supported and studied in NTN in upcoming 3GPP Rel-18.

Currently, details regarding how to reconnect a radio link for a multi-connectivity scenario in a large propagation delay environment, e.g., a NTN environment, have not been discussed.

### SUMMARY

Some embodiments of the present application also provide a user equipment (UE). The UE includes a processor and a wireless transceiver coupled to the processor; and the processor is configured: to determine, based on a time related condition, whether to perform a recovery operation to reconnect the UE to a master node (MN) or at least one secondary node (SN), wherein the time related condition is associated with “the MN” or “the at least one SN” or “the MN and the at least one SN”; and to perform the recovery operation, in response to determining that the recovery operation is to be performed.

Some embodiments of the present disclosure provide a method, which may be performed by a UE. The method includes: determining, based on a time related condition, whether to perform a recovery operation to reconnect the UE to a MN or at least one SN, wherein the time related condition is associated with “the MN” or “the at least one SN” or “the MN and the at least one SN”; and performing the recovery operation, in response to determining that the recovery operation is to be performed.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE.

Some embodiments of the present application also provide a network node. The network node includes a processor; and a wireless transceiver coupled to the processor, and the processor is configured: to generate configuration information relating to a recovery operation to reconnect the UE to a MN or at least one SN, wherein the configuration information includes a time related condition; and to transmit the configuration information via the wireless transceiver to a UE.

Some embodiments of the present application provide a method, which may be performed by a network node. The method includes: generating configuration information relating to a recovery operation to reconnect the UE to a MN or at least one SN, wherein the configuration information includes a time related condition; and transmitting the configuration information to a UE.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned further method performed by a network node.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIGS. 1 and 2 illustrate exemplary cases when DC or multi-connectivity is supported in a NTN and a terrestrial network (TN) in accordance with some embodiments of the present application;

FIG. 3 illustrates an exemplary block diagram of an apparatus in accordance with some embodiments of the present application;

FIG. 4 illustrates an exemplary flow chart of a method for performing a radio link reconnecting operation in accordance with some embodiments of the present application;

FIG. 5 illustrates an exemplary flow chart of a method for transmitting configuration information relating to a recovery operation in accordance with some embodiments of the present application; and

FIG. 6 illustrates an exemplary flow chart of radio link reconnecting for multi-connectivity in accordance with some embodiments of the present application.

### DETAILED DESCRIPTION

The detailed description of the appended drawings is intended as a description of the currently preferred embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

Also, the use of the expression “A and/or B” means any one of the following: “A” alone or “B” alone; or both “A” and “B” together.

Reference will now be made in detail to some embodiments of the present disclosure, examples of which are illustrated in the accompanying drawings. To facilitate understanding, embodiments are provided under specific network architecture and new service scenarios, such as 3GPP 5G New Radio (NR), 3GPP long-term evolution (LTE) Release 8 and so on. Persons skilled in the art know very well that, with the development of network architecture and new service scenarios, the embodiments in the present disclosure are also applicable to other similar technical problems.

In a MR-DC mechanism, a radio link failure (RLF) may be detected at MCG and SCG. A RLF is declared separately for the MCG and SCG:
(1) For a MCG, an RRC procedure called fast MCG link recovery is designed where to allow the UE to send the MCGFailureInformation message to the MN via the SCG upon the detection of a RLF on the MCG. Upon a RLF on MCG, if fast MCG link recovery is configured (timer T316 configured), the UE triggers a fast MCG link recovery and waits for recovery or release message from MN via the SCG. If timer T316 expires or fast MCG link recovery is not configured, the UE initiates the RRC connection re-establishment procedure.
(2) For a SCG when a RLF failure is detected, if MCG transmissions of radio bearers are not suspended, the UE suspends SCG transmissions for all radio bearers and reports the SCGFailureInformation message to the MN, instead of triggering a RRC connection re-establishment procedure. The MN handles the SCGFailureInformation message and may decide to keep, change, or release the SN or SCG. If a SCG failure is detected while MCG transmissions for all radio bearers are suspended, the UE initiates the RRC connection re-establishment procedure.

For multi-connectivity which could be supported in future 3GPP specification releases, it is expected that MCG or SCG failure recovery will use the above-mentioned MR-DC mechanism as baseline.

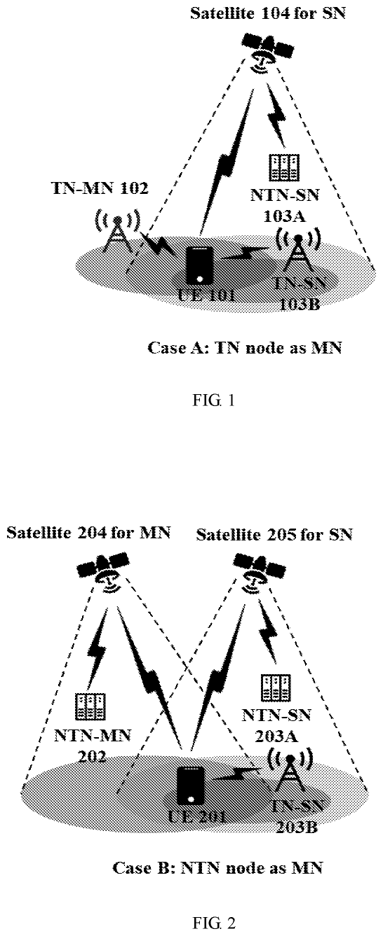

FIGS. 1 and 2 illustrate exemplary cases when DC or multi-connectivity is supported in a NTN and a terrestrial network (TN) in accordance with some embodiments of the present application.

As shown in FIG. 1, the wireless communication system includes one UE, i.e., UE 101, and four BSs, i.e., TN-MN 102, NTN-SN 103A, NTN-SN 103B, and satellite 104 for SN. As shown in FIG. 2, the wireless communication system includes one UE, i.e., UE 201, and five BSs, i.e., TN-MN 202, NTN-SN 203A, NTN-SN 203B, satellite 204 for MN, and satellite 205 for SN.

Although merely a specific number of BSs are illustrated in FIGS. 1 and 2 for simplicity, it is contemplated that the wireless communication system in any of FIGS. 1 and 2 may include more or less BSs in some other embodiments of the present application. Similarly, although merely one UE is illustrated in FIGS. 1 and 2 for simplicity, it is contemplated that the wireless communication system in any of FIGS. 1 and 2 may include more UEs in some other embodiments of the present application.

Each BS in FIG. 1 or FIG. 2 may also be referred to as an access point, an access terminal, a base, a macro cell, a node-B, an enhanced node B (eNB), a gNB, a home node-B, a relay node, or a device, or described using other terminology used in the art. Each BS in FIG. 1 or FIG. 2 is generally part of a radio access network that may include a controller communicably coupled to each BS.

UE 101 or UE 201 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, UE 101 or UE 201 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, UE 101 or UE 201 may include wearable devices, such as smart watches, fitness bands, optical head-mounted displays, or the like. Moreover, UE 101 or UE 201 may be referred to as a subscriber unit, a mobile, a mobile station, a user, a terminal, a mobile terminal, a wireless terminal, a fixed terminal, a subscriber station, a user terminal, or a device, or described using other terminology used in the art.

The wireless communication system in FIG. 1 or FIG. 2 is compatible with any type of network that is capable of sending and receiving wireless communication signals. For example, the wireless communication system in FIG. 1 or FIG. 2 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP based network, a 3GPP 5G network, a satellite communications network, a high altitude platform network, and/or other communications networks.

In particular, in Case A as shown in FIG. 1, a TN node functions as a MN, and NTN or TN node(s) functions as SN(s), which is expected to take the advantage of NTN coverage in mobility performance and robustness. In Case B as shown in FIG. 2, NTN node functions as a MN, and NTN or TN node(s) functions as SN(s), which is expected to improve the throughput performance and robustness, or to compensate for the disadvantage of large propagation delay in NTN.

Currently, for both Case A as shown in FIG. 1 and Case B as shown in FIG. 2, following issues may occur:
(1) Issue #1: SN/SCG selection for MCGFailureInformation transmission in a MCG recovery. If multiple SCGs, e.g., NTN SN(s) and/or TN SN(s), are configured, a UE needs to determine which SN(s) or SCG(s) is to be selected or activated to send the MCGFailureInformation message, as NTN SNs may have large propagation delays or reminting service time of satellites.
(2) Issue #2: SN/SCG-specific timer T316 configuration for a MCG recovery. As NTN SNs may have large propagation delays or reminting service time of satellites, it may not be appropriate to configure one UE-specific timer T316 for all SN(s) or SCG(s).
(3) Issue #3: SN losting during a MCG recovery. If NTN SN(s) is configured, during the MCG recovery procedure, a UE could lose its connection to SN(s), e.g., due to a LEO satellite's movement.
(4) Issue #4: Predictable SN losting or a predictable RLF on a SCG. “A SN losting” or “a RLF on a SCG” could be predicted, e.g., derived from a LEO satellite's ephemeris.

For Case B as shown in FIG. 2, following issues may occur:
(1) Issue #5: MN losting during a SCG recovery. During the MCG/SCG recovery procedure, a UE could lose its connection to the MN, e.g., due to a LEO satellite's movement.
(2) Issue #6: Predictable MN losting or a predictable RLF on a MCG. “A MN losting” or “a RLF on a MCG” could be predicted, e.g., derived from a LEO satellite's ephemeris.

In general, the NTN characters, which include a large propagation delay and a satellite's movement and etc., are causes of above-mentioned issues. Embodiments of the present application aim to solve the above-mentioned issues while taking these NTN characters into consideration.

In particular, some embodiments of the present application provide a radio link reconnecting method for a UE in a multi-connectivity scenario, especially with cases of a large propagation delay and/or cases involving possible “MN losting” or “SN losting”, e.g., a NTN environment. Some embodiments of the present application allow a UE with a multi-connectivity to determine operation(s) to reconnect to a MN or a SN, based on the UE's propagation delay to the MN or the SN and/or based on the MN's remaining serving time or the SN's remaining serving time. Some embodiments of the present application allow a UE to find an optimized option of recovering its MCG or SCG radio link with a lower recovery delay or a higher recovery success rate.

Some embodiments of the present application consider impacts of a recovery delay and a satellite's availability on a MCG or SCG recovery due to a NTN deployment. In some embodiments of the present application, based on (pre-) configured criteria, a UE may choose to perform a fast MCG recovery, to perform a RRC re-establishment procedure while skipping a fast MCG recovery, or to perform a preliminary report of a predicted failure on a MCG or a SCG. Some embodiments of the present application allow a UE to find an optimal way of attempting radio link reconnecting in a multi-connectivity scenario. Some embodiments of the present application provide a network node with additional information in determining radio link reconnecting configuration in a multi-connectivity scenario. More details will be illustrated in the following text in combination with the appended drawings.

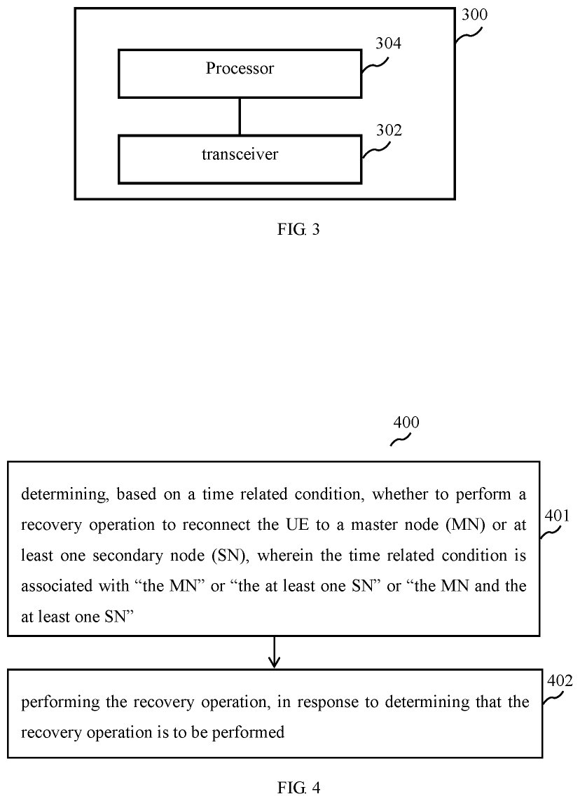

FIG. 3 illustrates an exemplary block diagram of an apparatus in accordance with some embodiments of the present application. As shown in FIG. 3, the apparatus 300 may include at least one processor 304 and at least one transceiver 302 coupled to the processor 304. The apparatus 300 may be a UE or a network node.

Although in this figure, elements such as the at least one transceiver 302 and processor 304 are described in the singular, the plural is contemplated unless a limitation to the singular is explicitly stated. In some embodiments of the present application, the transceiver 302 may be divided into two devices, such as a receiving circuitry and a transmitting circuitry. In some embodiments of the present application, the apparatus 300 may further include an input device, a memory, and/or other components.

In some embodiments of the present application, the apparatus 300 may be a UE (e.g., UE 101, UE 201, or UE 620 as illustrated and shown in any of FIGS. 1, 2, and 6). The processor 304 of the UE may be configured: to determine, based on a time related condition, whether to perform a recovery operation to reconnect the UE to a MN or at least one SN; and to perform the recovery operation, in response to determining that the recovery operation is to be performed. The time related condition may be associated with “the MN” or “the at least one SN” or “the MN and the at least one SN”.

According to some embodiments, the time related condition may be configured, by a network node (e.g., TN-MN 102, NTN-SN 103A, NTN-SN 103B, satellite 104 for SN, TN-MN 202, NTN-SN 203A, NTN-SN 203B, satellite 204 for MN, or satellite 205 for SN as illustrated and shown in any of FIGS. 1, 2, and 6), to the UE. According to some other embodiments, the time related condition may be pre-configured to the UE. In some embodiments, the time related condition includes at least one of:
(1) a single trip time delay between the UE and the MN;
(2) a round trip time delay between the UE and the MN;
(3) a single trip time delay between the UE and the at least one SN;
(4) a round trip time delay between the UE and the at least one SN;
(5) a single trip time delay between the MN and the at least one SN;
(6) a round trip time delay between the MN and the at least one SN;
(7) the MN's remaining serving time for the UE;
(8) the at least one SN's remaining serving time for the UE;
(9) a 1st time condition associated with an absolute time threshold;
(10) a 2nd time condition associated with an absolute time range;
(11) a 3rd time condition associated with a relative time threshold; or
(12) a 4th time condition associated with a relative time range.

In an embodiment, “the 3rd time condition associated with the relative time threshold” or “the 4th time condition associated with the relative time range” may be associated with:
(1) whether the at least one SN is in a TN or a NTN;
(2) whether the at least one SN uses a GEO satellite or a LEO satellite;
(3) whether the at least one SN is configured with configured grant (CG); or
(4) whether the at least one SN is configured with Type 1 CG.

In some embodiments, the processor 304 of the UE may be configured: to determine to perform the recovery operation, in response to fulfilling the time related condition; or to determine not to perform the recovery operation, in response to not fulfilling the time related condition.

In an embodiment, the time related condition is fulfilled if a sum of “a round trip time delay between the UE and the at least one SN” and “a round trip time delay between the MN and the at least one SN” is not greater than one of:
(1) A length value of a timer for radio resource control (RRC) connection recovery (e.g., timer T316). This timer is applied at the UE.
(2) A round trip time delay between the UE and the MN.
(3) Two times of “the round trip time delay between the UE and the MN” (i.e., twice the round trip time delay between the UE and the MN).
(4) The MN's remaining serving time for the UE.
(5) The at least one SN's remaining serving time for the UE.
(6) A time threshold for performing a MCG recovery procedure or a RRC re-establishment procedure. This time threshold may be configured by a network node or the UE.
(7) A further time threshold for performing a SCG recovery procedure or the RRC re-establishment procedure. This further time threshold may be configured by a network node or the UE.

According to some embodiments, if a RLF occurs on a MCG, the recovery operation includes one of:
(1) selecting or activating the at least one SN, and transmitting MCG failure information to the at least one SN;
(2) applying a length value to a timer for RRC connection recovery (e.g., timer T316). This timer is associated with the at least one SN. The length value is specific for the at least one SN;
(3) applying an offset value to a further timer for RRC connection recovery (e.g., timer T316). This further timer is associated with the UE. The offset value is specific for the at least one SN; or
(4) skipping a transmission of the MCG failure information via the at least one SN.

In some embodiments, after skipping the transmission of the MCG failure information via the at least one SN, the processor 304 of the UE may be configured to trigger a RRC re-establishment procedure.

In some embodiments, in response to predicting that “a RLF will occur on a MCG” or “the MN will lost”, the recovery operation includes triggering a preliminary transmission of the MCG failure information without the RLF on the MCG. In an embodiment, in response to predicting that “the RLF will occur on the MCG” or “the MN will lost”, the recovery operation includes transmitting an indication which indicates that “the RLF is predicted on the MCG” or “the MN will lost”.

In some further embodiments, the recovery operation includes one of:
(1) skipping a transmission of SCG failure information to the MN, if a RLF occurs on a SCG; or
(2) triggering a preliminary transmission of the SCG failure information without the RLF on the SCG, if the UE predicts that “the RLF will occur on the SCG” or “the at least one SN will lost”.

In some embodiments, if a RLF occurs on a SCG, the processor 304 of the UE may be configured: to skip the transmission of SCG failure information to the MN; and to trigger a RRC re-establishment procedure. In some other embodiments, if a RLF occurs on a SCG, the processor 304 of the UE may be configured: to skip the transmission of SCG failure information to the MN; and to transmit a RRC release request message to the MN.

In some embodiments, in response to predicting that “the RLF will occur on the SCG” or “the at least one SN will lost”, the recovery operation includes transmitting an indication which indicates that “the RLF is predicted on the SCG” or “the at least one SN will lost”.

According to some embodiments, the processor 304 of the UE is configured: to receive, via the transceiver 302 from a network node, configuration information relating to the recovery operation. In some embodiments, the configuration information includes at least one of:
(1) The time related condition, based on which the processor 304 of the UE is configured to determine whether to perform recovery operation to reconnect the UE to a MN or at least one SN.
(2) A determining criteria regarding whether the time related condition is fulfilled or not.
(3) Information relating to the recovery operation.
(4) A single trip time delay between the MN and the at least one SN.
(5) A round trip time delay between the MN and the at least one SN.
(6) A length value of a timer for RRC connection recovery (e.g., timer T316). This timer is associated with the at least one SN. The length value is specific for the at least one SN. In an embodiment, if a RLF occurs on a MCG and if the at least one SN is selected or activated for a fast MCG recovery procedure, the processor 304 of the UE is configured to apply the length value to this timer.
(7) An offset value to a further timer for RRC connection recovery (e.g., timer T316). This further timer is associated with the UE. The offset value is specific for the at least one SN. In an embodiment, if a RLF occurs on a MCG and if the at least one SN is selected or activated for a fast MCG recovery procedure, the processor 304 of the UE is configured to apply the offset value to this further timer.

In some embodiments, the processor 304 of the UE is configured to transmit, via the transceiver 302, reporting information to a network node. For example, the reporting information may include at least one of:
(1) An indication to indicate a predicted failure. For example, a new failure type is as an indication, e.g., predictFailure information element (IE).
(2) A location of the UE.
(3) A prediction result of the UE. The prediction result may include at least one of: the MN losting, the at least one SN losting, a failure (e.g., a RLF) on a MCG, or a failure (e.g., a RLF) on a SCG.
(4) Relative time when the prediction result of the UE appears. In an example, the relative time is a time length (e.g., 2 minutes) from the time when the UE makes the prediction result to the time when the prediction result of the UE appears. In a further example, the relative time is a time length range (e.g., greater than or less than RTT) in view of reference time.
(5) Absolute time when the prediction result of the UE appears. In an example, the absolute time is UTC time when the prediction result of the UE appears.
(6) A prediction reason of the prediction result of the UE. In an embodiment, the prediction reason includes at least one of: an expiration of the MN's remaining serving time for the UE; or an expiration of the at least one SN's remaining serving time for the UE.

In some embodiments of the present application, the apparatus 300 may be a network node (e.g., TN-MN 102, NTN-SN 103A, NTN-SN 103B, satellite 104 for SN, TN-MN 202, NTN-SN 203A, NTN-SN 203B, satellite 204 for MN, or satellite 205 for SN as illustrated and shown in any of FIGS. 1, 2, and 6). The processor 304 of the network node may be configured: to generate, configuration information relating to a recovery operation to reconnect the UE to a MN or at least one SN; and to transmit the configuration information via the transceiver 302 to a UE (e.g., UE 101, UE 201, or UE 620 as illustrated and shown in any of FIGS. 1, 2, and 6). The configuration information includes a time related condition, based on which the UE determines whether to perform recovery operation to reconnect the UE to a MN or at least one SN.

According to some embodiments, the configuration information further includes at least one of:
(1) A determining criteria regarding whether the time related condition is fulfilled or not.
(2) Information relating to the recovery operation.
(3) A single trip time delay between the MN and the at least one SN.
(4) A round trip time delay between the MN and the at least one SN.
(5) A length value of a timer for RRC connection recovery (e.g., timer T316). This timer is associated with the at least one SN. The length value is specific for the at least one SN.
(6) An offset value to a further timer for RRC connection recovery (e.g., timer T316). This further timer is associated with the UE. The offset value is specific for the at least one SN.

In some embodiments, the time related condition, based on which the UE determines whether to perform the recovery operation, includes at least one of:
(1) A single trip time delay between the UE and the MN.
(2) A round trip time delay between the UE and the MN.
(3) A single trip time delay between the UE and the at least one SN.
(4) A round trip time delay between the UE and the at least one SN.
(5) A single trip time delay between the MN and the at least one SN.
(6) A round trip time delay between the MN and the at least one SN.
(7) The MN's remaining serving time for the UE.
(8) The at least one SN's remaining serving time for the UE.
(9) A 1st time condition associated with an absolute time threshold.
(10) A 2nd time condition associated with an absolute time range.
(11) A 3rd time condition associated with a relative time threshold.
(12) A 4th time condition associated with a relative time range.

In some embodiments, “the 3rd time condition associated with the relative time threshold” or “the 4th time condition associated with the relative time range” may be associated with:
(1) whether the at least one SN is in a TN or a NTN;
(2) whether the at least one SN uses a GEO satellite or a LEO satellite;
(3) whether the at least one SN is configured with CG; or
(4) whether the at least one SN is configured with Type 1 CG.

In some embodiments, the processor 304 of the network node may be configured to receive, via the transceiver 302, reporting information from the UE. For example, the reporting information may include at least one of:
(1) An indication to indicate a predicted failure. For example, a new failure type is as an indication, e.g., predictFailure IE.
(2) A location of the UE.
(3) A prediction result of the UE. The prediction result may include: the MN losting, the at least one SN losting, a failure (e.g., a RLF) on a MCG, and/or a failure (e.g., a RLF) on a SCG.
(4) Relative time when the prediction result of the UE appears. In an example, the relative time is a time length (for instance, 2 minutes) from the time when the UE makes the prediction result to the time when the prediction result of the UE appears. In a further example, the relative time is a time length range (for instance, greater than or less than RTT) in view of reference time.
(5) Absolute time (e.g., UTC time) when the prediction result of the UE appears.
(6) A prediction reason of the prediction result of the UE. In an embodiment, the prediction reason includes: an expiration of the MN's remaining serving time for the UE; and/or an expiration of the at least one SN's remaining serving time for the UE.

In an embodiment, the time related condition is fulfilled if a sum of “a round trip time delay between the UE and the at least one SN” and “a round trip time delay between the MN and the at least one SN” is not greater than one of:
(1) A length value of a timer for RRC connection recovery (e.g., timer T316). This timer is applied at the UE.
(2) A round trip time delay between the UE and the MN.
(3) Two times of the round trip time delay between the UE and the MN.
(4) The MN's remaining serving time for the UE.
(5) The at least one SN's remaining serving time for the UE.
(6) A time threshold for performing a MCG recovery procedure or a RRC re-establishment procedure. This time threshold may be configured by a network node or the UE.
(7) A further time threshold for performing a SCG recovery procedure or the RRC re-establishment procedure. This further time threshold may be configured by a network node or the UE.

According to some embodiments, if a RLF occurs on a MCG, the recovery operation includes one of:
(1) Selecting or activating the at least one SN, and transmitting MCG failure information to the at least one SN.
(2) Applying a length value to a timer for RRC connection recovery (e.g., timer T316). This timer is associated with the at least one SN. The length value is specific for the at least one SN.
(3) Applying an offset value to a further timer for RRC connection recovery (e.g., timer T316). This further timer is associated with the UE. The offset value is specific for the at least one SN.
(4) Skipping a transmission of the MCG failure information via the at least one SN. In some embodiments, after skipping the transmission of the MCG failure information via the at least one SN, the UE may trigger a RRC re-establishment procedure.

In some embodiments, in response to predicting that “a RLF will occur on a MCG” or “the MN will lost”, the recovery operation includes triggering a preliminary transmission of the MCG failure information without the RLF on the MCG. In an embodiment, in response to predicting that “the RLF will occur on the MCG” or “the MN will lost”, the recovery operation includes transmitting an indication which indicates that the RLF is predicted on the MCG or the MN will lost.

According to some embodiments, the recovery operation includes one of:
(1) skipping a transmission of SCG failure information to the MN; or
(2) triggering a preliminary transmission of the SCG failure information without the RLF on the SCG, if the UE predicts that “the RLF will occur on the SCG” or “the at least one SN will lost”.

In some embodiments, if a RLF occurs on a SCG, the UE may skip the transmission of SCG failure information to the MN; and trigger a RRC re-establishment procedure. In some other embodiments, if a RLF occurs on a SCG, the UE may skip the transmission of SCG failure information to the MN and transmit a RRC release request message to the MN.

In some embodiments, in response to predicting that “the RLF will occur on the SCG” or “the at least one SN will lost”, the recovery operation includes transmitting an indication which indicates that “the RLF is predicted on the SCG” or “the at least one SN will lost”.

In some embodiments of the present application, the apparatus 300 may include at least one non-transitory computer-readable medium. In some embodiments, the non-transitory computer-readable medium may have stored thereon computer-executable instructions to cause a processor to implement the method with respect to a UE or a network node as described above. For example, the computer-executable instructions, when executed, cause the processor 304 interacting with transceiver 302, so as to perform operations of the methods, e.g., as described in view of any of FIGS. 4-6.

FIG. 4 illustrates an exemplary flow chart of a method for performing a radio link reconnecting operation in accordance with some embodiments of the present application. The exemplary method 400 illustrated in FIG. 4 may be implemented by a UE (e.g., UE 101, UE 201, or UE 620 as illustrated and shown in any of FIGS. 1, 2, and 6). Although described with respect to a UE, it should be understood that other devices may be configured to perform a method similar to that of FIG. 4.

In the embodiments of FIG. 4, in operation 401, a UE (e.g., UE 101-A as shown in FIG. 1) determines, based on a time related condition, whether to perform a recovery operation to reconnect the UE to a MN or at least one SN. The time related condition is associate with “the MN” or “the at least one SN” or “the MN and the at least one SN”. In operation 402, the UE performs the recovery operation, in response to determining that the recovery operation is to be performed.

According to some embodiments, the time related condition is configured, by a network node, to the UE. According to some other embodiments, the time related condition is pre-configured to the UE. In some embodiments, the time related condition includes at least one of:
(1) A single trip time delay between the UE and the MN.
(2) A round trip time delay between the UE and the MN.
(3) A single trip time delay between the UE and the at least one SN.
(4) A round trip time delay between the UE and the at least one SN.
(5) A single trip time delay between the MN and the at least one SN.
(6) A round trip time delay between the MN and the at least one SN.
(7) The MN's remaining serving time for the UE.
(8) The at least one SN's remaining serving time for the UE.
(9) A 1st time condition associated with an absolute time threshold.
(10) A 2nd time condition associated with an absolute time range.
(11) A 3rd time condition associated with a relative time threshold.
(12) A 4th time condition associated with a relative time range.

In an embodiment, “the 3rd time condition associated with the relative time threshold” or “the 4th time condition associated with the relative time range” may be associated with:
(1) whether the at least one SN is in a TN or a NTN;
(2) whether the at least one SN uses a GEO satellite or a LEO satellite;
(3) whether the at least one SN is configured with CG; or
(4) whether the at least one SN is configured with Type 1 CG.

According to some embodiments, the UE further determines to perform the recovery operation, in response to fulfilling the time related condition. According to some embodiments, the UE further determines not to perform the recovery operation, in response to not fulfilling the time related condition.

In an embodiment, the time related condition is fulfilled if a sum of “a round trip time delay between the UE and the at least one SN” and “a round trip time delay between the MN and the at least one SN” is not greater than one of:
(1) A length value of a timer for RRC connection recovery (e.g., timer T316). This timer is applied at the UE.
(2) A round trip time delay between the UE and the MN.
(3) Two times of the round trip time delay between the UE and the MN.
(4) Remaining serving time of the MN for the UE.
(5) Remaining serving time of the at least one SN for the UE.
(6) A time threshold for performing a MCG recovery procedure or a RRC re-establishment procedure. This time threshold may be configured by a network node or the UE.
(7) A further time threshold for performing a SCG recovery procedure or the RRC re-establishment procedure. This further time threshold may be configured by a network node or the UE.

According to some embodiments, if a RLF occurs on a MCG, the recovery operation includes one of:
(1) Selecting or activating the at least one SN, and transmitting MCG failure information to the at least one SN.
(2) Applying a length value to a timer for RRC connection recovery (e.g., timer T316). This timer is associated with the at least one SN. The length value is specific for the at least one SN.
(3) Applying an offset value to a further timer for RRC connection recovery (e.g., timer T316). This further timer is associated with the UE. The offset value is specific for the at least one SN.
(4) Skipping a transmission of the MCG failure information via the at least one SN. In some embodiments, after skipping the transmission of the MCG failure information via the at least one SN, the UE may trigger a RRC re-establishment procedure.

In some embodiments, in response to predicting that “a RLF will occur on a MCG” or “the MN will lost”, the recovery operation includes triggering a preliminary transmission of the MCG failure information without the RLF on the MCG. In an embodiment, in response to predicting that “the RLF will occur on the MCG” or “the MN will lost”, the recovery operation includes transmitting an indication which indicates that “the RLF is predicted on the MCG” or “the MN will lost”.

According to some embodiments, the recovery operation includes one of:
(1) skipping a transmission of SCG failure information to the MN, if a RLF occurs on a SCG; or
(2) triggering a preliminary transmission of the SCG failure information without the RLF on the SCG, if the UE predicts that “the RLF will occur on the SCG” or “the at least one SN will lost”.

In some embodiments, if a RLF occurs on a SCG, the UE may skip the transmission of SCG failure information to the MN and trigger a RRC re-establishment procedure. In some other embodiments, if a RLF occurs on a SCG, the UE may skip the transmission of SCG failure information to the MN and transmit a RRC release request message to the MN.

In some embodiments, in response to predicting that “the RLF will occur on the SCG” or “the at least one SN will lost”, the recovery operation includes transmitting an indication which indicates that “the RLF is predicted on the SCG” or “the at least one SN will lost”.

In some embodiments, the UE further receives, from a network node, configuration information relating to the recovery operation. In some embodiments, the configuration information includes at least one of:
(1) The time related condition, based on which the UE determines whether to perform the recovery operation in operation 401 in the embodiments of FIG. 4.
(2) A determining criteria regarding whether the time related condition is fulfilled or not.
(3) Information relating to the recovery operation.
(4) A single trip time delay between the MN and the at least one SN.
(5) A round trip time delay between the MN and the at least one SN.
(6) A length value of a timer for RRC connection recovery (e.g., timer T316). This timer is associated with the at least one SN. The length value is specific for the at least one SN. In an embodiment, if a RLF occurs on a MCG and if the at least one SN is selected or activated for a fast MCG recovery procedure, the UE may apply the length value to this timer.
(7) An offset value to a further timer for RRC connection recovery (e.g., timer T316). This further timer is associated with the UE. The offset value is specific for the at least one SN. In an embodiment, if a RLF occurs on a MCG and if the at least one SN is selected or activated for a fast MCG recovery procedure, the UE may apply the offset value to this further timer.

According to some embodiments, the UE may transmit reporting information to a network node. For example, the reporting information may include at least one of:
(1) An indication to indicate a predicted failure. For example, a new failure type is as an indication, e.g., predictFailure IE.
(2) A location of the UE.
(3) A prediction result of the UE. For instance, the prediction result may include: the MN losting, the at least one SN losting, a failure (e.g., a RLF) on a MCG, and/or a failure (e.g., a RLF) on a SCG.
(4) Relative time when the prediction result of the UE appears. In an example, the relative time is a time length (for instance, 2 minutes) from the time when the UE makes the prediction result to the time when the prediction result of the UE appears. In a further example, the relative time is a time length range (for instance, greater than or less than RTT) in view of reference time.
(5) Absolute time (e.g., UTC time) when the prediction result of the UE appears.
(6) A prediction reason of the prediction result of the UE. In an embodiment, the prediction reason includes: an expiration of remaining serving time of the MN for the UE; and/or an expiration of remaining serving time of the at least one SN for the UE.

Details described in all of the foregoing embodiments (e.g., embodiments of FIGS. 3, 5, and 6) of the present disclosure (especially, contents regarding how to reconnect a radio link for a multi-connectivity scenario) are applicable for the embodiments shown in FIG. 4. Moreover, details described in the embodiments of FIG. 4 are applicable for all the embodiments of FIGS. 1-3, 5, and 6. It should be appreciated by persons skilled in the art that the sequence of the operations in exemplary procedure in the embodiments of FIG. 4 may be changed and some of the operations in exemplary procedure in the embodiments of FIG. 4 may be eliminated or modified, without departing from the spirit and scope of the disclosure.

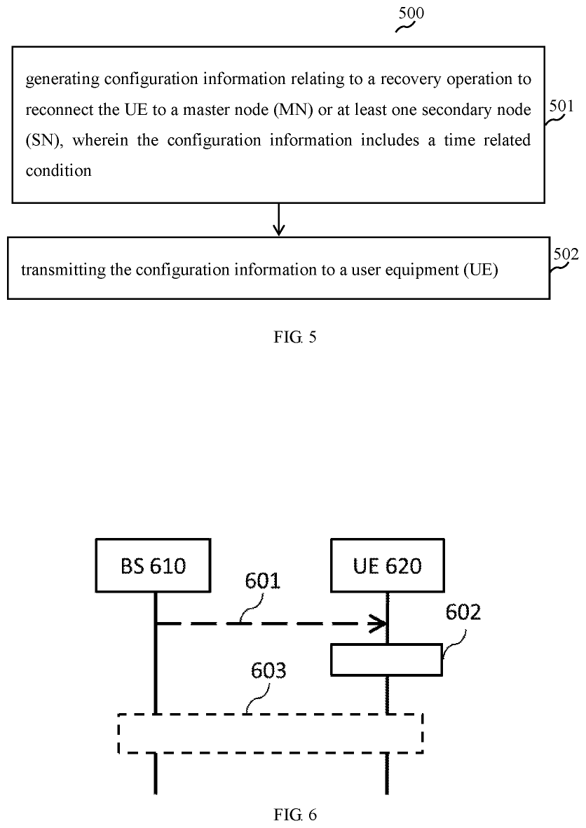

FIG. 5 illustrates an exemplary flow chart of a method for transmitting configuration information relating to a recovery operation in accordance with some embodiments of the present application. The exemplary method 500 illustrated in FIG. 5 may be implemented by a network node, e.g., a BS (e.g., TN-MN 102, NTN-SN 103A, NTN-SN 103B, satellite 104 for SN, TN-MN 202, NTN-SN 203A, NTN-SN 203B, satellite 204 for MN, or satellite 205 for SN as illustrated and shown in any of FIGS. 1, 2, and 6). Although described with respect to a network node, it should be understood that other devices may be configured to perform a method similar to that of FIG. 5.

In the embodiments of FIG. 5, in operation 501, a network node generates configuration information relating to a recovery operation to reconnect the UE to a MN or at least one SN. The configuration information may include a time related condition, based on which the UE determines whether to perform the recovery operation to reconnect the UE to a MN or at least one SN. In operation 502, the network node transmits the configuration information to a UE.

According to some embodiments, the configuration information may further include at least one of:
(1) A determining criteria regarding whether the time related condition is fulfilled or not.
(2) Information relating to the recovery operation.
(3) A single trip time delay between the MN and the at least one SN.
(4) A round trip time delay between the MN and the at least one SN.
(5) A length value of a timer for RRC connection recovery (e.g., timer T316). This timer is associated with the at least one SN. The length value is specific for the at least one SN.
(6) An offset value to a further timer for RRC connection recovery (e.g., timer T316). This further timer is associated with the UE. The offset value is specific for the at least one SN.

In some embodiments, the time related condition, based on which the UE determines whether to perform a recovery operation to reconnect the UE to a MN or at least one SN, includes at least one of:
(1) a single trip time delay between the UE and the MN;
(2) a round trip time delay between the UE and the MN;
(3) a single trip time delay between the UE and the at least one SN;
(4) a round trip time delay between the UE and the at least one SN;
(5) a single trip time delay between the MN and the at least one SN;
(6) a round trip time delay between the MN and the at least one SN;
(7) remaining serving time of the MN for the UE;
(8) remaining serving time of the at least one SN for the UE;
(9) a 1st time condition associated with an absolute time threshold;
(10) a 2nd time condition associated with an absolute time range;
(11) a 3rd time condition associated with a relative time threshold; or
(12) a 4th time condition associated with a relative time range.

In an embodiment, “the 3rd time condition associated with the relative time threshold” or “the 4th time condition associated with the relative time range” may be associated with:
(1) whether the at least one SN is in a TN or a NTN;
(2) whether the at least one SN uses a GEO satellite or a LEO satellite;
(3) whether the at least one SN is configured with CG; or
(4) whether the at least one SN is configured with Type 1 CG.

In some embodiments, the network node may receive reporting information from the UE. For example, the reporting information may include at least one of:
(1) An indication to indicate a predicted failure. For example, a new failure type is as an indication, e.g., predictFailure IE.
(2) A location of the UE.
(3) A prediction result of the UE. The prediction result may include: the MN losting, the at least one SN losting, a failure (e.g., a RLF) on a MCG, and/or a failure (e.g., a RLF) on a SCG.
(4) Relative time when the prediction result of the UE appears. In an example, the relative time is a time length (for instance, 2 minutes) from the time when the UE makes the prediction result to the time when the prediction result of the UE appears. In a further example, the relative time is a time length range (for instance, greater than or less than RTT) in view of reference time.
(5) Absolute time (e.g., UTC time) when the prediction result of the UE appears.
(6) A prediction reason of the prediction result. In an embodiment, the prediction reason includes: an expiration of remaining serving time of the MN for the UE; and/or an expiration of remaining serving time of the at least one SN for the UE.

In an embodiment, the time related condition is fulfilled if a sum of “a round trip time delay between the UE and the at least one SN” and “a round trip time delay between the MN and the at least one SN” is not greater than one of:
(1) A length value of a timer for RRC connection recovery (e.g., timer T316). This timer is applied at the UE.
(2) A round trip time delay between the UE and the MN.
(3) Two times of the round trip time delay between the UE and the MN.
(4) The at least one SN's remaining serving time for the UE.
(5) The MN's remaining serving time for the UE.
(6) A time threshold for performing a MCG recovery procedure or a RRC re-establishment procedure. This time threshold may be configured by a network node or the UE.
(7) A further time threshold for performing a SCG recovery procedure or the RRC re-establishment procedure. This further time threshold may be configured by a network node or the UE.

According to some embodiments, if a RLF occurs on a MCG, the recovery operation includes one of:
(1) Selecting or activating the at least one SN, and transmitting MCG failure information to the at least one SN.
(2) Applying a length value to a timer for RRC connection recovery (e.g., timer T316). This timer is associated with the at least one SN. The length value is specific for the at least one SN.
(3) Applying an offset value to a further timer for RRC connection recovery (e.g., timer T316). This further timer is associated with the UE. The offset value is specific for the at least one SN.
(4) Skipping a transmission of the MCG failure information via the at least one SN. In some embodiments, after skipping the transmission of the MCG failure information via the at least one SN, the UE may trigger a RRC re-establishment procedure.

In some embodiments, if the UE predicts that “a RLF will occur on a MCG” or “the MN will lost”, the recovery operation may include triggering a preliminary transmission of the MCG failure information without the RLF on the MCG. In an embodiment, if the UE predicts that “the RLF will occur on the MCG” or “the MN will lost”, the recovery operation may include transmitting an indication which indicates that “the RLF is predicted on the MCG” or “the MN will lost”.

According to some other embodiments, the recovery operation includes one of:
(1) in response to a RLF occurring on a SCG, skipping a transmission of SCG failure information to the MN; or
(2) in response to predicting that “the RLF will occur on the SCG” or “the at least one SN will lost”, triggering a preliminary transmission of the SCG failure information without the RLF on the SCG.

In some embodiments, if a RLF occurs on a SCG, the UE may skip the transmission of SCG failure information to the MN and trigger a RRC re-establishment procedure. In some other embodiments, if a RLF occurs on a SCG, the UE may skip the transmission of SCG failure information to the MN and transmit a RRC release request message to the MN.

In some embodiments, in response to predicting that “the RLF will occur on the SCG” or “the at least one SN will lost”, the recovery operation includes transmitting an indication which indicates that “the RLF is predicted on the SCG” or “the at least one SN will lost”.

Details described in all of the foregoing embodiments (e.g., embodiments of FIGS. 3, 4, and 6) of the present disclosure (especially, contents regarding how to reconnect a radio link for a multi-connectivity scenario) are applicable for the embodiments shown in FIG. 5. Moreover, details described in the embodiments of FIG. 4 are applicable for all the embodiments of FIGS. 1-3, 4, and 6. It should be appreciated by persons skilled in the art that the sequence of the operations in exemplary procedure in the embodiments of FIG. 5 may be changed and some of the operations in exemplary procedure in the embodiments of FIG. 5 may be eliminated or modified, without departing from the spirit and scope of the disclosure.

FIG. 6 illustrates an exemplary flow chart of radio link reconnecting for multi-connectivity in accordance with some embodiments of the present application.

In operation 601, BS 610 transmits, to UE 620, configuration information relating to a recovery operation to reconnect UE 620 to a MN or at least one SN. The configuration information includes a time related condition. Such configuration information may also be named as “configuration of a MCG or SCG recovery based on a time related condition of a MN or at least one SN” or the like. As shown in FIG. 6, the operation 601 is optional in some embodiments of FIG. 6 and thus is marked as a dashed line. That is to say, in some embodiments, the time related condition is configured by BS 610 to UE 620. In some other embodiments, the time related condition may be pre-configured to UE 620.

In operation 602, UE 620 determines, based on the time related condition included in the configuration information, whether to perform a recovery operation to reconnect UE 620 to the MN or the at least one SN. In other words, UE 620 determines a MCG or SCG recovery based on the time related condition of the MN or the at least one SN.

In some embodiments of FIG. 6, in operation 603, BS 610 and UE 620 may perform a fast MCG recovery procedure, a fast SCG recovery procedure, and/or a RRC re-establishment procedure.

Details described in all other embodiments of the present application (for example, details of how to reconnect a radio link for a multi-connectivity scenario) are applicable for the embodiments of FIG. 6. Moreover, details described in the embodiments of FIG. 6 are applicable for all the embodiments of FIGS. 1-5.

The following texts describe specific Embodiments 1-4 of the methods as shown and illustrated in FIGS. 4-6. According to Embodiments 1-4, a UE and a network node perform following operations. The UE may be UE 101, UE 201, or UE 620 as illustrated and shown in any of FIGS. 1, 2, and 6. The network node may be TN-MN 102, NTN-SN 103A, NTN-SN 103B, satellite 104 for SN, TN-MN 202, NTN-SN 203A, NTN-SN 203B, satellite 204 for MN, or satellite 205 for SN as illustrated and shown in any of FIGS. 1, 2, and 6.

### Embodiment 1

In Embodiment 1, a UE has a multiple connectivity to a MN and at least one SN. Upon a failure (e.g., a RLF) on a MCG, the UE may determine operation(s) to reconnect to the MN, based on a time related condition of the UE's connection to the MN and/or the at least one SN as follows:
(1) Option 1: For a fast MCG recovery, the UE selects or activates a SN with round trip time (RTT) of “UE to SN to MN” no larger than its applied timer T316 value, to transmit MCG failure information to the selected or activated SN. In this case, a connection between the UE and the MN could be recovered before timer T316 expires.
(2) Option 2: For a fast MCG recovery, the UE selects or activates a SN with “UE to SN to MN” RTT no larger than 2 times of “UE to MN” RTT, to transmit MCG failure information to the selected or activated SN. In this case, a connection between the UE and the MN could be recovered faster via the selected or activated SN than a re-establishment using 4-step random access (RA) procedure.
(3) Option 3: For a fast MCG recovery, the UE selects or activates a SN with “UE to SN to MN” RTT no larger than “UE to MN” RTT, to transmit MCG failure information to the selected or activated SN. In this case, a connection between the UE and the MN could be recovered faster via the selected or activated SN than a re-establishment using 2-step RA procedure.
(4) Option 4: For a fast MCG recovery, UE selects or activates a SN with “UE to SN to MN” RTT no larger than the remaining serving time of the SN, to transmit MCG failure information to the selected or activated SN. In this case, the availability of the selected or activated SN can be guaranteed during the fast MCG recovery.
(5) Option 5: For a fast MCG recovery, the UE selects or activates a SN with “UE to SN to MN” RTT no larger than the remaining serving time of the MN, to transmit MCG failure information to the selected or activated SN. In this case, the availability of the MN can be guaranteed during the fast MCG recovery.
(6) Option 6: For a fast MCG recovery, the UE selects or activates a SN with “UE to SN to MN” RTT no larger than a time threshold.
(7) Option 7: For a fast MCG recovery, the UE selects or activates a SN belonging to TN in a higher priority than a SN belonging to a NTN, to transmit MCG failure information to the selected or activated SN. In this case, the TN is assumed to be with lower propagation delay and higher stability.
(8) Option 8:
   a) Option 8A: For a fast MCG recovery, the UE selects or activates a SN using a GEO satellite in a higher priority than a SN using a LEO satellite, to transmit MCG failure information. In this case, a GEO satellite is assumed to be with higher stability, while a LEO satellite is assumed to be with lower stability.
   b) Option 8B: For a fast MCG recovery, the UE selects or activates a SN using a LEO satellite in a higher priority than a SN using a GEO satellite, to transmit MCG failure information. In this case, a GEO satellite is assumed to be with higher propagation delay, while a LEO satellite is assumed to be with lower propagation delay.
(9) Option 9: Upon a RLF on a MCG, the UE selects or activates at least one SN to transmit MCG failure information, wherein the UE selects or activates a SN with CG configuration or Type 1 CG configuration in priority.
(10) Option 10: For a fast MCG recovery, the UE selects or activates a SN with criterion configured by a network node, to transmit MCG failure information, and the configured criterion includes at least one of the above-mentioned Options (1)˜(9).
(11) Option 11: If none of SN(s) for the UE fulfill at least one of the above-mentioned Options (1)˜(10), the UE skips a fast MCG recovery and triggers a RRC re-establishment procedure to the MN. In a message during the RRC re-establishment procedure or a message after completing the RRC re-establishment procedure, the UE may transmit a reason of skipping the fast MCG recovery, e.g., “SN is with large propagation delay” or “SN is with short remaining serving time”.

### Embodiment 2

In Embodiment 2, a UE has a multiple connectivity to a MN and at least one SN. Upon a failure (e.g., a RLF) on a SCG, the UE may determine operation(s) to reconnect to a SN, based on a time related condition of the UE's connection to the MN and/or the at least one SN as follows:
(1) Option 1: For a SCG recovery to a SN, the UE transmits SCG failure information to the MN, if “UE to MN” RTT is not larger than twice “UE to SN” RTT. In this case, a connection between the UE and the SN could be recovered faster than a re-establishment using a 4-step RA procedure.
(2) Option 2: For a SCG recovery to a SN, the UE transmits SCG failure information to the MN, if “UE to MN” RTT is not larger than “UE to SN” RTT. In this case, a connection between the UE and the SN could be recovered faster than a re-establishment using 2-step RA procedure.
(3) Option 3: For a SCG recovery to a SN, the UE transmits SCG failure information to the MN, if “UE to MN” RTT is not larger than remaining serving time of the MN. In this case, the availability of the MN can be guaranteed during the SCG recovery.
(4) Option 4: For a SCG recovery to a SN, the UE transmits SCG failure information to the MN, if “UE to MN” RTT is not larger than remaining serving time of the SN. In this case, the availability of the SN can be guaranteed during the SCG recovery.
(5) Option 5: For a SCG recovery to a SN, the UE transmits SCG failure information to the MN, if “UE to MN” RTT is not larger than a time threshold. The time threshold may be (pre-) configured to the UE.
(6) Option 6: For a SCG recovery, the UE transmits SCG failure information to the MN with criterion configured by a network node, to transmit SCG failure information, wherein the configured criterion includes at least one of the above-mentioned Options (1)˜(5).
(7) Option 7: If “UE to MN” RTT does not fulfill at least one of the above-mentioned Options (1)˜(6), the UE skips a SCG recovery and triggers a RRC re-establishment procedure or transmits a RRC release request message for the SN.
   a) In a case that the UE triggers the RRC re-establishment procedure, in a message during the RRC re-establishment procedure or a message after completing the RRC re-establishment procedure, the UE may transmit a reason of skipping the SCG recovery. In a case that the UE transmits the RRC release request message, in the RRC release request message, the UE may transmit the reason of skipping the SCG recovery. For example, the reason of skipping the SCG recovery may be “SN is with large propagation delay” or “SN is with short remaining serving time”.
(8) Option 8: If the MN belongs to a specific network type (e.g., NTN), or uses a specific platform (e.g., GEO or LEO satellite), the UE skips the SCG recovery and triggers a RRC re-establishment procedure or transmit a RRC release request message for the SN.
   a) In a case that the UE triggers the RRC re-establishment procedure, in a message during the RRC re-establishment procedure or a message after completing the RRC re-establishment procedure, the UE may transmit a reason of skipping the SCG recovery. In a case that the UE transmits the RRC release request message, in the RRC release request message, the UE may transmit the reason of skipping the SCG recovery. For example, the reason of skipping the SCG recovery may be “MN is with large propagation delay” or “MN is with short remaining serving time”.

### Embodiment 3

In Embodiment 3, a UE has a multiple connectivity to a MN and at least one SN. If the UE may predict “an upcoming MN lost” or “a RLF on a MCG”, based on the MN's trajectory (e.g., satellite ephemeris) and/or the MN's remaining serving time, the UE could trigger a preliminary transmission of MCG failure information without detecting an actual RLF on the MCG. If the UE may predict “an upcoming SN lost” or “a RLF on a SCG” based on the at least one SN's trajectory (e.g., satellite ephemeris) and/or the at least one SN's remaining serving time, the UE could trigger a preliminary transmission of SCG failure information without detecting an actual RLF on the SCG.

For instance, the UE could indicate “a predicted MN losting”, “a predicted SN losting”, “a failure on a MCG”, “a failure on a SCG”, “a reason of a predicted failure on a MCG”, and/or “a reason of a predicted failure on a SCG”, to a network node via RRC signaling. For example, “a reason of a predicted failure on a MCG” may include an expiration of remaining serving time of the MN. For example, “a reason of a predicted failure on a SCG” may include an expiration of remaining serving time of the SN.

In Embodiment 3, the predicted MCG failure and/or its reason can be indicated in failure Type in FailureReportMCG in a MCGFailureInformation message. The predicted SCG failure and/or its reason can be indicated in failureType in FailureReportSCG in a SCGFailureInformation message. Two possible examples of implementations in 3GPP specifications are as follows, i.e., Example 1 and Example 2.

### Example 1

### 3GPP TS 38.331 V16.5.0 (2021-06)

### MCGFailureInformation

The MCGFailureInformation message is used to provide information regarding NR
MCG failures detected by the UE.
1> Signaling radio bearer: SRB1
2> RLC-SAP: AM
3> Logical channel: DCCH
4> Direction: UE to Network

### MCGFailureInformation Message

-- ASN1START
-- TAG-MCGFAILUREINFORMATION-START

| | |
|---|---|
| MCGFailureInformation-r16 ::= | SEQUENCE { |
| criticalExtensions | CHOICE { |
| mcgFailureInformation-r16 | MCGFailureInformation-r16-IEs, |
| criticalExtensionsFuture | SEQUENCE { } |

}
}
MCGFailureInformation-r16-IEs ::= SEQUENCE {

| | |
|---|---|
| failureReportMCG-r16 | FailureReportMCG-r16 |

OPTIONAL,

| | | |
|---|---|---|
| lateNonCriticalExtension | OCTET STRING | OPTIONAL, |
| nonCriticalExtension | SEQUENCE { } | OPTIONAL |

}

| | |
|---|---|
| FailureReportMCG-r16 ::= | SEQUENCE { |

| | |
|---|---|
| failureType-r16 | ENUMERATED {t310-Expiry, |

randomAccessProblem, rlc-MaxNumRetx, t312-Expiry-r16, lbt-Failure-r16,

| beamFailureRecoveryFailure-r16, bh-RLF-r16, spare1} | | OPTIONAL, |
|---|---|---|
| measResultFreqList-r16 | MeasResultList2NR | OPTIONAL, |
| measResultFreqListEUTRA-r16 | MeasResultList2EUTRA | OPTIONAL, |
| measResultSCG-r16 | OCTET STRING | (CONTAINING |

MeasResultSCG-Failure) OPTIONAL,

| | | |
|---|---|---|
| measResultSCG-EUTRA-r16 | OCTET STRING | OPTIONAL, |

| | |
|---|---|
| measResultFreqListUTRA-FDD-r16 | MeasResultList2UTRA OPTIONAL, |

...
[[

| | |
|---|---|
| failureType-v18xy | ENUMERATED |
| {predictFailure-r18, spare4, spare3, spare2, spare1} | OPTIONAL |

]]
}

| | |
|---|---|
| MeasResultList2UTRA ::= | SEQUENCE (SIZE (1..maxFreq)) OF |

MeasResult2UTRA-FDD-r16

| | |
|---|---|
| MeasResult2UTRA-FDD-r16 ::= | SEQUENCE { |
| carrierFreq-r16 | ARFCN-ValueUTRA-FDD-r16, |
| measResultNeighCellList-r16 | MeasResultListUTRA-FDD-r16 |

}

| | |
|---|---|
| MeasResultList2EUTRA ::= | SEQUENCE (SIZE (1..maxFreq)) OF |

MeasResult2EUTRA-r16
-- TAG-MCGFAILUREINFORMATION-STOP
-- ASN1STOP

### MCGFailureInformation Field Descriptions

(1) measResultFreqList

The field contains available results of measurements on NR frequencies the UE is configured to measure by measConfig associated with the MCG.

(2) measResultFreqListEUTRA

The field contains available results of measurements on E-UTRA frequencies the UE is configured to measure by measConfig associated with the MCG.

(3) measResultFreqListUTRA-FDD

The field contains available results of measurements on UTRA FDD frequencies the UE is configured to measure by measConfig associated with the MCG.

(4) measResultSCG

The field contains the MeasResultSCG-Failure IE which includes available measurement results on NR frequencies the UE is configured to measure by measConfig associated with the SCG.

(5) measResultSCG-EUTRA

The field contains the EUTRA MeasResultSCG-FailureMRDC IE which includes available results of measurements on E-UTRA frequencies the UE is configured to measure by the E-UTRA RRCConnectionReconfiguration message as specified in TS 36.331 [10].

### Example 2

### 3GPP TS 38.331 V16.5.0 (2021-06)

### SCGFailureInformation

The SCGFailureInformation message is used to provide information regarding NR SCG failures detected by the UE.
1> Signaling radio bearer: SRB1
2> RLC-SAP: AM
3> Logical channel: DCCH
4> Direction: UE to Network

### SCGFailureInformation Message

-- ASN1START
-- TAG-SCGFAILUREINFORMATION-START

| | |
|---|---|
| SCGFailureInformation ::= | SEQUENCE { |
| criticalExtensions | CHOICE { |
| scgFailureInformation | SCGFailureInformation-IEs, |
| criticalExtensionsFuture | SEQUENCE { } |

}
}

| SCGFailureInformation-IEs ::= | SEQUENCE { | |
|---|---|---|
| failureReportSCG | FailureReportSCG | OPTIONAL, |
| nonCriticalExtension | SCGFailureInformation-v1590-Ies | OPTIONAL |

}

| SCGFailureInformation-v1590-IEs ::= | SEQUENCE { | |
|---|---|---|
| lateNonCriticalExtension | OCTET STRING | OPTIONAL, |
| nonCriticalExtension | SEQUENCE { } | OPTIONAL |

}

| FailureReportSCG ::= | SEQUENCE { | |
|---|---|---|
| failureType | | ENUMERATED |
| {t310-Expiry, | randomAccessProblem, | rlc-MaxNumRetx, |

synchReconfigFailureSCG, scg-ReconfigFailure, srb3-IntegrityFailure, other-r16,
spare1},

| | | |
|---|---|---|
| measResultFreqList | MeasResultFreqList | OPTIONAL, |

| | |
|---|---|
| measResultSCG-Failure | OCTET STRING |
| (CONTAINING MeasResultSCG-Failure) | OPTIONAL, |

```
    ...,
    [[
```

| | | |
|---|---|---|
| locationInfo-r16 | LocationInfo-r16 | OPTIONAL, |

| | |
|---|---|
| failureType-v1610 | ENUMERATED {scg-lbtFailure-r16, |

beamFailureRecoveryFailure-r16, t312-Expiry-r16, bh-RLF-r16, spare4, spare3,

| | |
|---|---|
| spare2, spare1} | OPTIONAL |

]]
[[

| | |
|---|---|
| failureType-v18xy | ENUMERATED |
| {predictFailure-r18, spare4, spare3, spare2, spare1} | OPTIONAL |

]]
}

| | |
|---|---|
| MeasResultFreqList ::= | SEQUENCE (SIZE (1..maxFreq)) |

OF MeasResult2NR
-- TAG-SCGFAILUREINFORMATION-STOP
-- ASN1STOP

### SCGFailureInformation Field Descriptions

(1) measResultFreqList

The field contains available results of measurements on NR frequencies the UE is configured to measure by measConfig.

(2) measResultSCG-Failure

The field contains the MeasResultSCG-Failure IE which includes available results of measurements on NR frequencies the UE is configured to measure by the NR SCG RRCReconfiguration message.

### Embodiment 4

In Embodiment 4, a network node configures a UE, via dedicated signaling or broadcasting, with configuration(s) of performing operation(s) to reconnect the UE to a MN or at least one SN, based on a time related condition of the UE's connection to the MN and/or the at least one SN. The configuration(s) could include at least one of the following:
(1) Criteria to determine a MCG recovery operation (which is the same as those in Embodiment 1, Embodiment 2, and/or Embodiment 3 as described above).
(2) Criteria to determine a SCG recovery operation (which is the same as those in Embodiment 1, Embodiment 2, and/or Embodiment 3 as described above).
(3) The single trip time delay between a MN and a SN.
(4) The round trip time delay between a MN and a SN.
(5) SN-specific timer T316 value. A UE should apply the SN-specific timer T316 value, if the corresponding SN is selected or activated for a fast MCG recovery.
(6) SN-specific time offset applied to a configured UE-specific timer T316 value. A UE should apply the SN-specific time offset, to extend the configured UE-specific timer T316 value or to offset the start of the configured UE-specific timer T316, if the corresponding SN is selected or activated for a fast MCG recovery.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

1. A user equipment (UE) in a multi-connectivity scenario, comprising:
at least one memory; and
at least one processor coupled with the at least one memory and configured to cause the UE to:
determine, based on a time related condition, whether to perform a recovery operation to reconnect the UE to a master node (MN) or to at least one secondary node (SN), wherein the time related condition is associated with at least one of the MN or the at least one SN; and
perform the recovery operation, in response to determining that the recovery operation is to be performed.

2. The UE of claim 1, wherein the time related condition is configured, by a network node, to the UE or pre-configured to the UE.

3. The UE of claim 1, wherein the time related condition includes at least one of:
a single trip time delay between the UE and the MN;
a round trip time delay between the UE and the MN;
a single trip time delay between the UE and the at least one SN;
a round trip time delay between the UE and the at least one SN;
a single trip time delay between the MN and the at least one SN;
a round trip time delay between the MN and the at least one SN;
remaining serving time of the MN for the UE;
remaining serving time of the at least one SN for the UE;
a time condition associated with an absolute time threshold;
a time condition associated with an absolute time range;
a time condition associated with a relative time threshold; or
a time condition associated with a relative time range.

4. The UE of claim 1, wherein, the at least one processor is further configured to cause the UE to:
determine to perform the recovery operation, in response to fulfilling the time related condition; or
determine not to perform the recovery operation, in response to not fulfilling the time related condition.

5. The UE of claim 1, wherein the time related condition is fulfilled in response to:
a sum of a round trip time delay between the UE and the at least one SN and a round trip time delay between the MN and the at least one SN being not greater than one of:
a length value of a timer for radio resource control (RRC) connection recovery, wherein the timer is applied at the UE;
a round trip time delay between the UE and the MN;
two times of the round trip time delay between the UE and the MN;
remaining serving time of the MN for the UE;
remaining serving time of the at least one SN for the UE;
a first time threshold for performing a master cell group (MCG) recovery procedure or a RRC re-establishment procedure; or
a second time threshold for performing a secondary cell group (SCG) recovery procedure or the RRC re-establishment procedure.

6. The UE of claim 1, wherein, in response to a radio link failure (RLF) occurring on a master cell group (MCG), the recovery operation includes the at least one processor configured to cause the UE to one of:
select or activate the at least one SN, and transmit MCG failure information to the at least one SN;
apply a length value to a first timer for radio resource control (RRC) connection recovery, wherein the first timer is associated with the at least one SN, and wherein the length value is specific for the at least one SN;
apply an offset value to a second timer for the RRC connection recovery, wherein the second timer is associated with the UE, and wherein the offset value is specific for the at least one SN; or
skip a transmission of the MCG failure information via the at least one SN.

7. The UE of claim 1, wherein, the recovery operation includes the at least one processor configured to cause the UE to one of:
in response to a radio link failure (RLF) occurring on a secondary cell group (SCG), skip a transmission of SCG failure information to the MN; or
in response to predicting that the RLF will occur on the SCG or the at least one SN will lose connection, trigger a preliminary transmission of the SCG failure information without the RLF on the SCG.

8. The UE of claim 7, wherein, in response to predicting that the RLF will occur on the SCG or the at least one SN will lose connection, the recovery operation includes the at least one processor configured to cause the UE to transmit an indication indicating that the RLF is predicted on the SCG or the at least one SN will lose connection.

9. The UE of claim 1, wherein the at least one processor is configured to cause the UE to transmit reporting information to a network node, and wherein the reporting information includes at least one of:
an indication to indicate a predicted failure;
a location of the UE;
a prediction result of the UE, wherein the prediction result includes at least one of: the MN; losing a connection, the at least one SN losing a connection, a failure on a master cell group (MCG), or a failure on a secondary cell group (SCG);
relative time when the prediction result appears;
absolute time when the prediction result appears; or
a prediction reason of the prediction result.

10. A network node, comprising:
at least one memory; and
at least one processor coupled with the at least one memory and configured to cause the network node to:
generate configuration information relating to a recovery operation to reconnect a user equipment (UE) to a master node (MN) or to at least one secondary node (SN), wherein the configuration information includes a time related condition; and
transmit, to the UE, the configuration information.

11. The network node of claim 10, wherein the configuration information further includes at least one of:
a determining criteria regarding whether the time related condition is fulfilled or not;
information relating to the recovery operation;
a single trip time delay between the MN and the at least one SN;
a round trip time delay between the MN and the at least one SN;
a length value of a first timer for radio resource control (RRC) connection recovery, wherein the first timer is associated with the at least one SN, and wherein the length value is specific for the at least one SN; or
an offset value to a second timer for the RRC connection recovery, wherein the second timer is associated with the UE, and wherein the offset value is specific for the at least one SN.

12. The network node of claim 10, wherein the time related condition includes at least one of:
a single trip time delay between the UE and the MN;
a round trip time delay between the UE and the MN;
a single trip time delay between the UE and the at least one SN;
a round trip time delay between the UE and the at least one SN;
a single trip time delay between the MN and the at least one SN;
a round trip time delay between the MN and the at least one SN;
remaining serving time of the MN for the UE;
remaining serving time of the at least one SN for the UE;
a time condition associated with an absolute time threshold;
a time condition associated with an absolute time range;
a time condition associated with a relative time threshold; or
a time condition associated with a relative time range.

13. The network node of claim 10, wherein the at least one processor is configured to cause the network node to receive reporting information from the UE, and wherein the reporting information includes at least one of:
an indication to indicate a predicted failure;
a location of the UE;
a prediction result of the UE, wherein the prediction result includes at least one of: the MN; losing a connection, the at least one SN losing a connection, a failure on a master cell group (MCG), or a failure on a secondary cell group (SCG);
relative time when the prediction result appears;
absolute time when the prediction result appears; or
a prediction reason of the prediction result.

14. The network node of claim 10, wherein the time related condition is fulfilled in response to:
a sum of a round trip time delay between the UE and the at least one SN and a round trip time delay between the MN and the at least one SN being not greater than one of:
a length value of a timer for radio resource control (RRC) connection recovery, wherein the timer is applied at the UE;
a round trip time delay between the UE and the MN;
two times of the round trip time delay between the UE and the MN;
remaining serving time of the MN for the UE;
remaining serving time of the at least one SN for the UE;
a first time threshold for performing a master cell group (MCG) recovery procedure or a RRC re-establishment procedure; or
a second time threshold for performing a secondary cell group (SCG) recovery procedure or the RRC re-establishment procedure.

15. The network node of claim 10, wherein, in response to a radio link failure (RLF) occurring on a master cell group (MCG), the recovery operation includes one of:
selecting or activating the at least one SN, and transmitting MCG failure information to the at least one SN;
applying a length value to a first timer for radio resource control (RRC) connection recovery, wherein the first timer is associated with the at least one SN, and wherein the length value is specific for the at least one SN;
applying an offset value to a second timer for the RRC connection recovery, wherein the second timer is associated with the UE, and wherein the offset value is specific for the at least one SN; or
skipping a transmission of the MCG failure information via the at least one SN.

16. A processor for wireless communication, comprising:
at least one controller coupled with at least one memory and configured to cause the processor to:
determine, based on a time related condition, whether to perform a recovery operation to reconnect a user equipment (UE) to a master node (MN) or to at least one secondary node (SN), wherein the time related condition is associated with at least one of the MN or the at least one SN; and
perform the recovery operation, in response to determining that the recovery operation is to be performed.

17. A method performed by a user equipment (UE), the method comprising:
determining, based on a time related condition, whether to perform a recovery operation to reconnect the UE to a master node (MN) or to at least one secondary node (SN), wherein the time related condition is associated with at least one of the MN or the at least one SN; and
performing the recovery operation in response to determining that the recovery operation is to be performed.

18. The method of claim 17, further comprising:
determining to perform the recovery operation, in response to fulfilling the time related condition; or
determining not to perform the recovery operation, in response to not fulfilling the time related condition.

19. The method of claim 17, wherein, in response to a radio link failure (RLF) occurring on a master cell group (MCG), the recovery operation includes one of:
selecting or activating the at least one SN, and transmitting MCG failure information to the at least one SN;
applying a length value to a first timer for radio resource control (RRC) connection recovery, wherein the first timer is associated with the at least one SN, and wherein the length value is specific for the at least one SN;
applying an offset value to a second timer for the RRC connection recovery, wherein the second timer is associated with the UE, and wherein the offset value is specific for the at least one SN; or
skipping a transmission of the MCG failure information via the at least one SN.

20. The method of claim 17, wherein the recovery operation includes one of:
in response to a radio link failure (RLF) occurring on a secondary cell group (SCG), skipping a transmission of SCG failure information to the MN; or
in response to predicting that the RLF will occur on the SCG or the at least one SN will lose connection, triggering a preliminary transmission of the SCG failure information without the RLF on the SCG.
